(19) United States
(12) Patent Application Publication
(10) Pub. No.: US 2025/0064019 A1
(43) Pub. Date: Feb. 27, 2025

(54) Animal and Reptile Catcher Device and Method of Use

(71) Applicant: Jacob Walraven, Yucca Valley, CA (US)

(72) Inventor: Jacob Walraven, Yucca Valley, CA (US)

(21) Appl. No.: 18/783,566

(22) Filed: Jul. 25, 2024

Related U.S. Application Data
(60) Provisional application No. 63/578,063, filed on Aug. 22, 2023.

(51) Int. Cl. A01K 15/00

(52) U.S. Cl. CPC A01K 15/003

(57) ABSTRACT

An animal or reptile catcher device to safely capture reptiles and small animals such as lizards for examination, relocation, or other purposes is disclosed. The device comprises a telescoping and tapered handle with a plurality of telescoping portions. The handle features a screw-off tip at the thinner end thereof, to which a loop is attached for positioning over an animal's head and tightening around the neck. In one embodiment, the loop includes an adjustable knot for manual tightening and loosening. Another embodiment incorporates a trigger mechanism near the top end of the handle, connected to a torsional spring and a cable that runs internally through the handle, enabling the loop to be automatically tightened or loosened by operating the trigger. The device is portable, lightweight, and provides a humane and efficient method for capturing and releasing small animals.

### CROSS-REFERENCE TO RELATED APPLICATION

The present application claims priority to, and the benefit of, U.S. Provisional Application No. 63/578,063, which was filed on Aug. 22, 2023, and is incorporated herein by reference in its entirety.

### FIELD OF THE INVENTION

The present invention generally relates to the field of animal capturing devices. More specifically, the present invention relates to a novel catch and release tool to trap lizards/reptiles and other small animals for fun and entertainment. The device includes a tapered handle generally shaped like a pool cue and includes a loop at one end to capture a lizard. The loop is secured around neck of the lizard and the loop can be loosened to release the animal without harm. Accordingly, the present disclosure makes specific reference thereto. Nonetheless, it is to be appreciated that aspects of the present invention are also equally applicable to other like applications, devices, and methods of manufacture.

### BACKGROUND

By way of background, children commonly experience boredom when playing with the same toys repeatedly, and adults can also become lazy and uninspired without engaging entertainment. Many individuals enjoy examining and interacting with small animals and reptiles in parks, outdoor areas, picnics, and more. The activity of examining small animals and reptiles is both popular and educational.

However, traditionally, individuals attempt to trap small animals and reptiles using their hands, which can pose significant risks. Handling such animals directly can lead to bites, scratches, or other injuries. Additionally, using conventional tools such as sticks or makeshift devices often results in harm to the animals, potentially causing injury or even death. Securely capturing these animals without causing them harm is also challenging for individuals. Animals frequently escape during capture attempts, leading to frustration and the potential for injury to both the animal/reptile and the handler. Accordingly, individuals desire a device that enables the safe and effective capture of small animals and reptiles.

Therefore, there exists a long felt need in the art for a portable and easy-to-use device that enables the safe and effective capture of small animals and reptiles. There is also a long felt need in the art for an animal or reptile catcher device that minimizes the risk of injury to both the animal/reptile and the user. Additionally, there is a long felt need in the art for special reptile or lizard catcher device that provides a secure means of trapping the animal for examination and subsequent release. Moreover, there is a long felt need in the art for a unique humane and efficient animal or reptile catcher device designed to safely capture and release small animals and reptiles. Further, there is a long felt need in the art for an animal or reptile catcher device that eliminates the requirement of a user to go near or touch the animal in order to capture the animal. Furthermore, there is a long felt need in the art for a catch and release tool to trap lizards/reptiles for fun and entertainment. Finally, there is a long felt need in the art for a uniquely designed practical and humane tool to capture lizards for examination, relocation, or other purposes.

The subject matter disclosed and claimed herein, in one embodiment thereof, comprises a portable animal or reptile catcher device. The catcher device is a handheld device and includes a telescoping and tapered handle having a plurality of telescoping portions, wherein the handle has a thicker top end and a thinner bottom end, a screw-off tip is removably attached to the thinner bottom end of the handle, a metal or plastic camouflaged loop is disposed on the screw-off tip, wherein the loop is configured to be positioned over an animal's head and tightened to secure the animal, and wherein the loop includes a knot that can run along the length of the loop to adjust the diameter and circumference of the loop. The loop can be loosened to release the animal after the examination of the animal is completed.

In this manner, the portable animal or reptile catcher device of the present invention accomplishes all of the forgoing objectives and provides users with a novel device that enables the safe and effective capture of small animals and reptiles. The device is easy to use, minimizes the risk of injury to both the animal/reptile and the user, and provides a secure means of trapping the animal for examination and subsequent release. The device is a practical and humane tool for individuals who want to capture lizards and other small animals for examination, relocation, or other purposes. The device prioritizes the safety and well-being of the lizards while providing an effective solution for the user.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a portable animal or reptile catcher device. The catcher device comprises a telescoping and tapered handle having a plurality of telescoping portions, wherein the handle has a thicker top end and a thinner bottom end, a screw-off tip is removably attached to the thinner bottom end of the handle, a loop is disposed on the screw-off tip, wherein the loop is configured to be positioned over an animal's head and tightened to secure the animal, and wherein the loop includes a knot that can run along the length of the loop to adjust the diameter and circumference of the loop.

In yet another embodiment, a reptile or lizard catcher device is disclosed. The reptile or lizard catcher device includes a telescoping and tapered handle having a plurality of telescoping portions, the handle extending (i.e., telescoping) up to about 8 feet in length, wherein the handle has a thicker top end with a diameter ranging from about 0.10 inches to about 1.50 inches and a thinner bottom end with a diameter ranging from about 0.10 inches to about 0.40 inches, a screw-off tip is removably attached to the thinner bottom end of the handle, a loop formed of a wire material is disposed on the screw-off tip, wherein the loop is configured to be positioned over an animal's head and tightened to secure the animal, and wherein the loop includes a knot that can run along the length of the loop to adjust the diameter and circumference of the loop.

In another embodiment, a portable and safe animal or reptile catcher device is disclosed. The animal or reptile catcher device comprises a telescoping and tapered handle having a plurality of telescoping portions, wherein the handle has a thicker top end and a thinner bottom end, a trigger mechanism is located near the thicker top end of the handle, a torsional spring is positioned inside the handle and coupled to the trigger mechanism, a cable runs internally through the handle and passes through a screw-off tip removably attached to the thinner bottom end of the handle, wherein the cable connects to a loop disposed on the screw-off tip, and wherein pulling the trigger mechanism compresses the torsional spring and pulls the cable to tighten the loop around an animal's neck, and releasing the trigger mechanism relaxes the torsional spring and loosens the loop.

In another aspect, the handle is made of a lightweight and durable material selected from the group consisting of wood, metal, and plastic.

In yet another aspect, the loop is made of a material selected from the group consisting of a metal, a rope, and a plastic and can be camouflaged to be less visible to animals.

In still another aspect, an ergonomic grip is disposed on the thicker top end for a secure grip of the handle.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of the animal/reptile catcher device of the present invention in accordance with the disclosed structure;

FIG. 2 illustrates a perspective view of another embodiment of the animal/reptile catcher device of the present invention in accordance with the disclosed structure;

FIG. 3 illustrates a perspective view showing use of the animal/reptile catcher device of the present invention in accordance with the disclosed structure; and

FIG. 4 illustrates a flow chart depicting a process of replacing a loop of the animal/reptile catcher device in accordance with the disclosed structure.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long felt need in the art for a portable and easy-to-use device that enables the safe and effective capture of small animals and reptiles. There is also a long felt need in the art for an animal or reptile catcher device that minimizes the risk of injury to both the animal/reptile and the user. Additionally, there is a long felt need in the art for special reptile or lizard catcher device that provides a secure means of trapping the animal for examination and subsequent release. Moreover, there is a long felt need in the art for a unique humane and efficient animal or reptile catcher device designed to safely capture and release small animals and reptiles. Further, there is a long felt need in the art for an animal or reptile catcher device that eliminates the requirement of a user to go near or touch the animal or reptile in order to capture the animal/reptile. Furthermore, there is a long felt need in the art for a catch and release tool to trap lizards/reptiles for fun and entertainment. Finally, there is a long felt need in the art for a uniquely designed practical and humane tool to capture lizards for examination, relocation, or other purposes.

The present invention, in one exemplary embodiment, is a portable and safe animal or reptile catcher device. The animal or reptile catcher device features a telescoping and tapered handle having a plurality of telescoping portions, wherein the handle has a thicker top end and a thinner bottom end, a trigger mechanism is located near the thicker top end of the handle, a torsional spring is positioned inside the handle and coupled to the trigger mechanism, a cable runs internally through the handle and passes through a screw-off tip removably attached to the thinner bottom end of the handle, wherein the cable connects to a loop disposed on the screw-off tip, and wherein pulling the trigger mechanism compresses the torsional spring and pulls the cable to tighten the loop around an animal's neck, and releasing the trigger mechanism relaxes the torsional spring and loosens the loop.

Reference will now be made in detail to the present preferred embodiments of the invention, examples of which are illustrated in the accompanying drawings. Wherever possible, the same reference numerals are used in the drawings and the description to refer to the same or like parts.

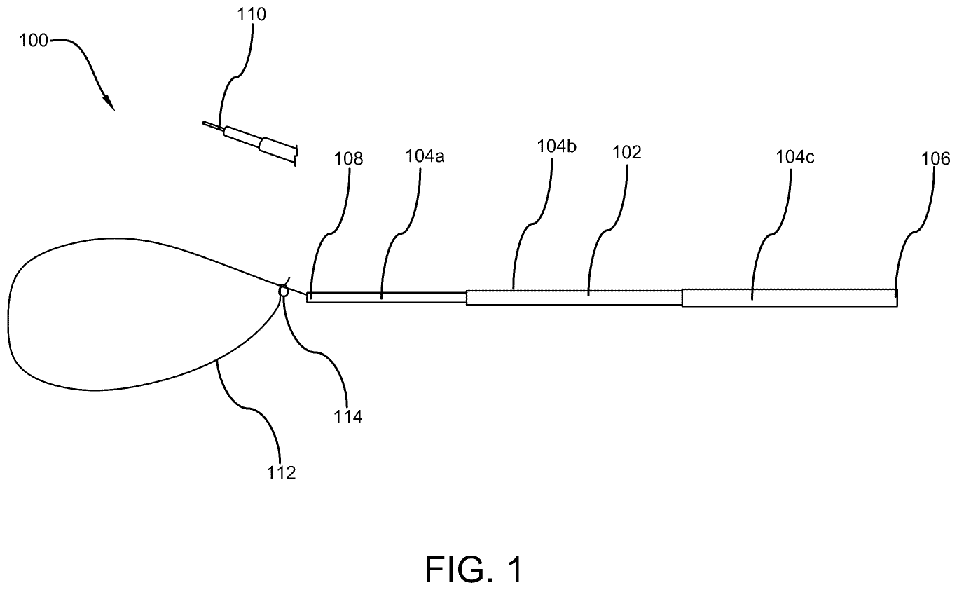

Referring initially to the drawings, FIG. 1 illustrates a perspective view of the animal or reptile catcher device of the present invention in accordance with the disclosed structure. The animal or reptile catcher device 100 of the present invention is designed to safely capture reptiles and small animals such as lizards for examination, relocation, or other purposes. More specifically, the reptile or animal catcher device 100 includes a telescoping and tapered handle 102 which includes a plurality of telescoping portions 104a-c. The extended length of the handle 102 can range (i.e., telescope or extend) from about 2 feet to about 8 feet to provide a sufficient reach to catch reptiles such as lizards without startling the reptiles or putting a user too close to the animal. The handle 102 can be made of wood, metal, plastic, or any other lightweight and durable material. The handle 102 is tapered and generally shaped like a pool cue and includes a thicker or larger top end 106 and a thinner or smaller bottom end 108. The thicker or top end 106 has a diameter from about 0.10 inches to about 1.50 inches and preferably, about 0.25 inches to about 0.75 inches. The thinner or bottom end 108 has a diameter from about 0.10 inches to about 0.40 inches and preferably about 0.125 inches to about 0.25 inches.

At the bottom end 108 of the handle 102, a screw-off tip 110 is removably screwed. A cord loop 112 formed of a rope, a wire, a plastic, and a cord are disposed on the screw-off tip 110 and is used for positioning over an animal's head and gently tightened around the neck to secure the animal. The cord loop 112 is preferably premade but can also be tied by a user depending on the animal or reptile to be caught using the device 100. In the present embodiment, the cord loop 112 is tightened manually by the user and is tightened to secure the lizard/animal without causing injury. The cord loop 112 can be loosened to release the lizard back into its environment unharmed.

The cord loop 112 includes a slip knot 114 that can run along a length of the cord loop 112 to adjust diameter and circumference of the cord loop 112 and therefore, enables a user to tighten and loosen the cord loop 112. The screw-off tip 110 can be removed from the handle 102 to replace the cord loop 112 or adjusting functionality of the device 100. The cord loop 112 can be camouflaged to make it less visible to animals.

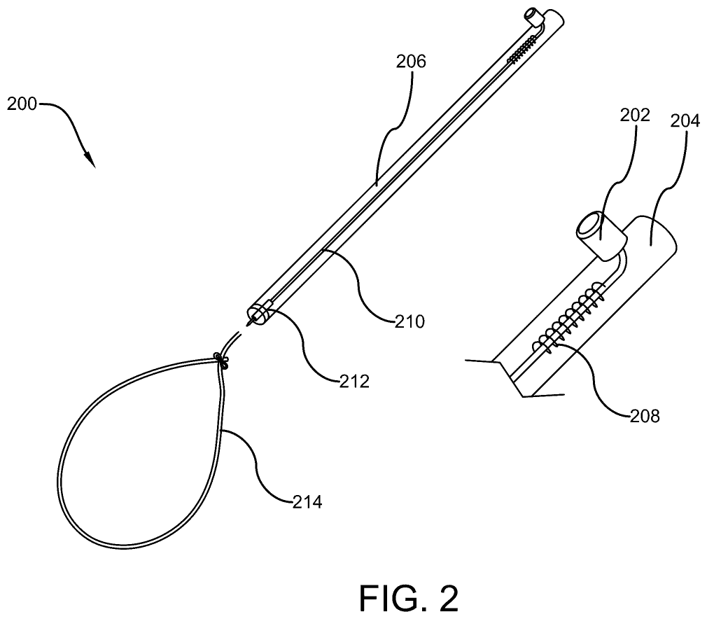

FIG. 2 illustrates a perspective view of another embodiment of the animal or reptile catcher device of the present invention in accordance with the disclosed structure. In the present embodiment, the animal or reptile catcher device 200 includes a trigger 202 near the top end 204 of the handle 206 and the trigger 202 is internally coupled to a torsional spring 208. The torsional spring 208 is positioned inside the handle 206. When the trigger 202 is pulled by the user, the spring 208 is adapted to be compressed and when the trigger 202 is released, the spring 208 is adapted to be released.

A cable 210 runs internally through the handle 206 and passes through an aperture in the screw-off tip 212 to connect to the loop 214. When the spring 208 is compressed, the cable 210 is pulled and the loop 214 is tightened automatically around an animal's neck. This helps in easy capturing of an animal such as a lizard without requiring the user to bend. For releasing the captured reptile or lizard, the trigger 202 is released to relax the spring 208 and loosening the loop 214 to release the lizard or animal. It will be apparent to a person skilled in the art that the loop 214 can be tightened or loosened depending on the extent of the trigger 202 being pulled (i.e., length of trigger pull) or released. In some embodiments, the trigger can be electronically actuated or can be motor controlled for loosening and tightening of the loop for releasing and catching a lizard or an animal.

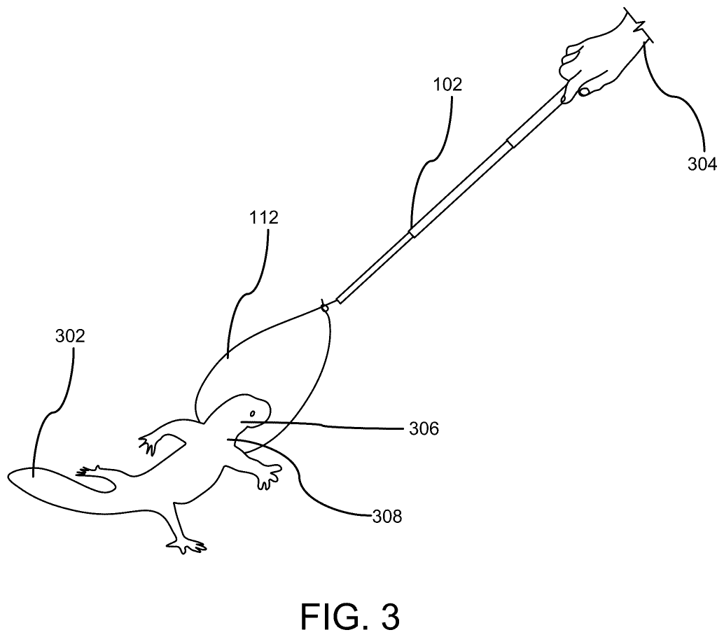

FIG. 3 illustrates a perspective view showing use of the small animal or reptile catcher device of the present invention in accordance with the disclosed structure. As illustrated, for catching a lizard or any other small animal or reptile 302, a user 304 holds the device 100 (or 200) from the top end 106 and places the cord loop 112 over the lizard's head 306. The loop can be camouflaged and once the cord loop 112 is around the lizard's neck 308, the cord loop 112 can be tightened by the user 304 either manually or by using the trigger as described earlier in the disclosure. The user 304 can examine or play with the lizard 302 when the lizard 302 is caught and after examination or other handling, the cord loop 112 can be loosened to release the lizard 302 back into its environment. The length of the handle 102 can be adjusted (i.e., telescoped or retracted) as per the preference by the user.

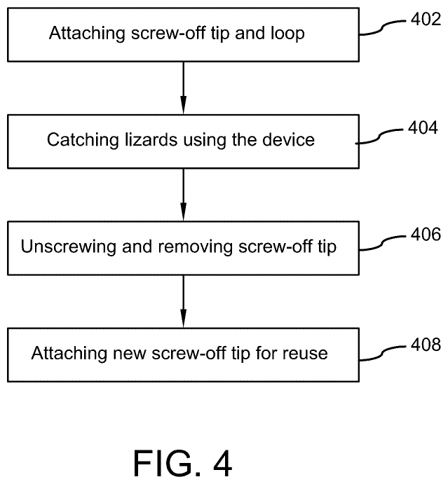

FIG. 4 illustrates a flow chart depicting a process of replacing a loop of the telescoping reptile or lizard catcher device in accordance with the disclosed structure. Initially, the screw-off tip of the device is screwed to the thinner end and the loop is attached to the screw-off tip (Step 402). The loop is used for catching lizards and other similar animals (Step 404). The loop can be tightened manually or by using the trigger. When the loop is damaged, the screw-off tip is unscrewed and removed from the handle (Step 406). Finally, a new screw-off tip with an attached loop is screwed to the thinner end of the handle for reusing the device (Step 408).

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “small animal or reptile catcher device”, “animal or reptile catcher device”, “reptile or lizard catcher device”, and “telescoping animal or reptile catcher device” are interchangeable and refer to the reptile and small animal telescoping catcher device 100, 200 of the present invention.

Notwithstanding the forgoing the reptile and small animal telescoping catcher device 100, 200 of the present invention can be of any suitable size and configuration as is known in the art without affecting the overall concept of the invention, provided that it accomplishes the above stated objectives. One of ordinary skill in the art will appreciate that the reptile and small animal telescoping catcher device 100, 200 as shown in the FIGS. are for illustrative purposes only, and that many other sizes and shapes of the reptile and small animal telescoping catcher device 100, 200 are well within the scope of the present disclosure. Although the dimensions the reptile and small animal telescoping catcher device 100, 200 are important design parameters for user convenience, the reptile and small animal telescoping catcher device 100, 200 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A reptile catcher device comprising:
a telescoping tapered handle;
a plurality of telescoping portions;
a selectively removable screw-off tip;
an adjustable cord loop having a slip knot;
a trigger having a torsional spring; and
a cable;
wherein said telescoping tapered handle having a top end including a top diameter, and a bottom end including a bottom diameter;
wherein said bottom diameter is less than said top diameter;
wherein said adjustable cord loop extending from said selectively removable screw-off tip;
wherein said bottom end having said selectively removable screw-off tip at a terminal end;
wherein said cable is connected to said adjustable cord;
wherein said adjustable cord loop is selected from the group consisting of a rope, a wire, a plastic, and a cord; and
further wherein pulling of said trigger compresses said torsional spring for pulling said cable and tightening said adjustable cord loop.

2. The reptile catcher device of claim 1, wherein said top diameter ranging from 0.10 inches to 1.50 inches.

3. The reptile catcher device of claim 2, wherein said bottom diameter ranging from 0.10 inches to 0.4 inches.

4. The reptile catcher device of claim 1, wherein said top diameter ranging from 0.25 inches to 0.75 inches.

5. The reptile catcher device of claim 4, wherein said bottom diameter ranging from 0.125 inches to 0.25 inches.

6. The reptile catcher device of claim 5, wherein said telescoping tapered handle extending from a length of 2 feet to 8 feet.

7. The reptile catcher device of claim 6, wherein said telescoping tapered handle having a material selected from the group consisting of a wood, a metal, and a plastic.

8. The reptile catcher device of claim 1, wherein said selectively removable screw-off tip removable for replacing said adjustable cord loop.

9. The reptile catcher device of claim 1, wherein releasing of said trigger decompresses said torsional spring for releasing said cable and loosening said adjustable cord loop.

10. The reptile catcher device of claim 9, wherein said cable internally coupled to said torsional spring within said telescoping tapered handle.

11. The reptile catcher device of claim 10, wherein said cable passes through an aperture in said selectively removable screw-off tip.

12. The reptile catcher device of claim 11, wherein the amount of movement of said cable is based on a length of pull of said trigger.

13. A reptile catcher device comprising:
a telescoping tapered handle;
a plurality of telescoping portions;
a selectively removable screw-off tip;
an adjustable cord loop having a slip knot;
a trigger having a torsional spring; and
a cable;
wherein said telescoping tapered handle having a top end including a top diameter, and a bottom end including a bottom diameter;
wherein said bottom diameter is less than said top diameter;
wherein said adjustable cord loop extending from said selectively removable screw-off tip;
wherein said bottom end having said selectively removable screw-off tip at a terminal end;
wherein said cable is connected to said adjustable cord;
wherein said adjustable cord loop is selected from the group consisting of a rope, a wire, a plastic, and a cord;
wherein pulling of said trigger compresses said torsional spring for pulling said cable and tightening said adjustable cord loop;
wherein releasing of said trigger decompresses said torsional spring for releasing said cable and loosening said adjustable cord loop;
wherein said cable internally coupled to said torsional spring within said telescoping tapered handle;
wherein said cable passes through an aperture in said selectively removable screw-off tip;
and
further wherein the amount of movement of said cable is based on a length of pull of said trigger.

14. The reptile catcher device of claim 13, wherein said top diameter ranging from 0.10 inches to 1.50 inches.

15. The reptile catcher device of claim 14, wherein said bottom diameter ranging from 0.10 inches to 0.4 inches.

16. The reptile catcher device of claim 13, wherein said top diameter ranging from 0.25 inches to 0.75 inches.

17. The reptile catcher device of claim 16, wherein said bottom diameter ranging from 0.125 inches to 0.25 inches.

18. The reptile catcher device of claim 13, wherein said telescoping tapered handle extending from a length of 2 feet to 8 feet.

19. The reptile catcher device of claim 13, wherein said telescoping tapered handle having a material selected from the group consisting of a wood, a metal, and a plastic.

20. A reptile catcher device comprising:
a telescoping tapered handle;
a plurality of telescoping portions;
a selectively removable screw-off tip;
an adjustable cord loop having a slip knot;
a trigger having a torsional spring; and
a cable;
wherein said telescoping tapered handle having a top end including a top diameter, and a bottom end including a bottom diameter;
wherein said bottom diameter is less than said top diameter;
wherein said adjustable cord loop extending from said selectively removable screw-off tip;
wherein said bottom end having said selectively removable screw-off tip at a terminal end;
wherein said cable is connected to said adjustable cord;
wherein said adjustable cord loop is selected from the group consisting of a rope, a wire, a plastic, and a cord;
wherein pulling of said trigger compresses said torsional spring for pulling said cable and tightening said adjustable cord loop;
wherein releasing of said trigger decompresses said torsional spring for releasing said cable and loosening said adjustable cord loop;
wherein said cable passes through an aperture in said selectively removable screw-off tip;
wherein the amount of movement of said cable is based on a length of pull of said trigger; and
further wherein said selectively removable screw-off tip removable for replacing said adjustable cord loop.
